(19) United States
(12) Patent Application Publication
(10) Pub. No.: US 2004/0036881 A1
(43) Pub. Date: Feb. 26, 2004

(54) Optical configuration for SPR measurement

(75) Inventors: Keshav D. Sharma, Lancaster, NY (US); Robert C. Atkinson, Buffalo, NY (US); Richard W. Lesch, Lancaster, NY (US)

Correspondence Address: Hodgson Russ LLP, Intellectual Property Law Group, One M & T Plaza, Suite 2000, Buffalo, NY, 14203-2391, US

(73) Assignee: Leica Microsystems Inc., Depew, NY

(21) Appl. No.: 10/225,699

(22) Filed: Aug. 22, 2002

(51) Int. Cl. G01N 21/55

(52) U.S. Cl. 356/445

(57) ABSTRACT

A method and apparatus for determining a characteristic of a substance is disclosed. The apparatus comprises a light source, a prism, a sensor chip located on the prism, focusing optics located between the light source and the prism, a detector, collimating optics located between the prism and the detector, and calculation means for determining the characteristic of the substance. The sensor chip comprises a metallic film and a transparent substance. The metallic film is operatively arranged to reflect light from the light source. The transparent substance comprises a material having an index of refraction matched to an index of refraction of the prism. The sensor chip is operatively arranged to receive a sample of the substance.

### FIELD OF THE INVENTION

The present invention relates generally to optical instruments for measuring refractive index of a substance, and more particularly to an optical configuration and method for measuring a refractive index of a sample. The present invention is applicable to surface plasmon resonance (SPR) biosensor devices.

### BACKGROUND OF THE INVENTION

The phenomenon of surface plasmon resonance, or SPR, is well known. SPR causes a drop in the intensity of light reflected from the interface of an optically transparent substance and a metal surface at a specific wavelength and angle of incidence. The location of the intensity minimum, measured with respect to wavelength or angle of incidence, changes when differing compositions of substances are placed in a sample space on the metal surface opposite the transparent substance. By measuring the location of the intensity minimum, the identity of the substance in contact with the metal surface may be determined.

Presently, the accuracy of the measurements is limited due to the spherical aberration of the light as it is incident on both the metallic film and the detector. Spherical aberration of the incident light results in multiple foci within the light beam. The multiple foci present in the beam cause the detector to measure a “hybrid” spectrum, rather than the desired intensity spectrum for an incident beam with a single focus. The hybrid spectrum is a superposition of the intensity spectra for all the foci present in the beam. This hybrid spectrum generally has a drop in the intensity level that is broader than the drop in the intensity spectrum for a single focus. The minimum of a broader drop is more difficult to compute accurately. Thus, the presence of spherical aberration decreases measurement accuracy and repeatability.

Further, the SPR measurement devices presently available can only measure indices of refraction in a limited range.

Clearly, then, there is a longfelt need for an SPR analysis apparatus that can reduce spherical aberration in the light beam and allow measurement of indices of refraction in the range of 1.3 to 1.4.

### SUMMARY OF THE INVENTION

The present invention comprises a method and apparatus for determining a characteristic of a substance. The apparatus comprises a light source, a prism, a sensor chip located on the prism, focusing optics located between the light source and the prism, a detector, collimating optics located between the prism and the detector, and calculation means for determining the characteristic of the substance. The sensor chip comprises a metallic film and a transparent substance. The metallic film is operatively arranged to reflect light from the light source. The transparent substance comprises a material having an index of refraction matched to an index of refraction of the prism. The sensor chip is operatively arranged to receive a sample of the substance. The focusing optics are operatively arranged to reduce spherical aberration of the light incident on the metallic film. The detector is operatively arranged to measure an intensity of light reflected by the metallic film. The collimating optics are operatively arranged to redirect the light reflected from the metallic film to substantially evenly illuminate the detector.

A general object of the present invention is to provide a method and apparatus for determining a characteristic of a substance.

Another object of the present invention is to determine an index of refraction of a substance.

A further object of the present invention is to determine indices of refraction of substances in the range from 1.3 to 1.4.

These and other objects, features and advantages of the present invention will become readily apparent to those having ordinary skill in the art upon a reading of the following detailed description of the invention in view of the drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is an exploded semi-schematic view of a preferred embodiment of the present invention;

FIG. 2 is a top view of the prism and sensor chip of a preferred embodiment of the present invention;

FIG. 2A is a side view of the prism and sensor chip of a preferred embodiment, taken at plane A-A of FIG. 2;

FIG. 2B is a cross sectional view of the prism and sensor chip of a preferred embodiment, taken at plane B-B of FIG. 2;

FIG. 3 is a top view of the prism and sensor chip of an alternate embodiment of the present invention;

FIG. 4 is a side view of the prism and sensor chip of an alternate embodiment of the present invention;

FIG. 5A is a view of light incident on a detector in a configuration wherein the incident light underfills the detector;

FIG. 5B is a view of light incident on a detector in a configuration wherein the incident light overfills the detector; and,

FIG. 6 is a view of the detector of the present invention wherein the incident light substantially evenly fills the detector.

### DETAILED DESCRIPTION OF THE PREFERRED EMBODIMENT

It should be appreciated that, in the detailed description of the invention which follows, like reference numbers on different drawing views are intended to identify identical structural elements of the invention in the respective views.

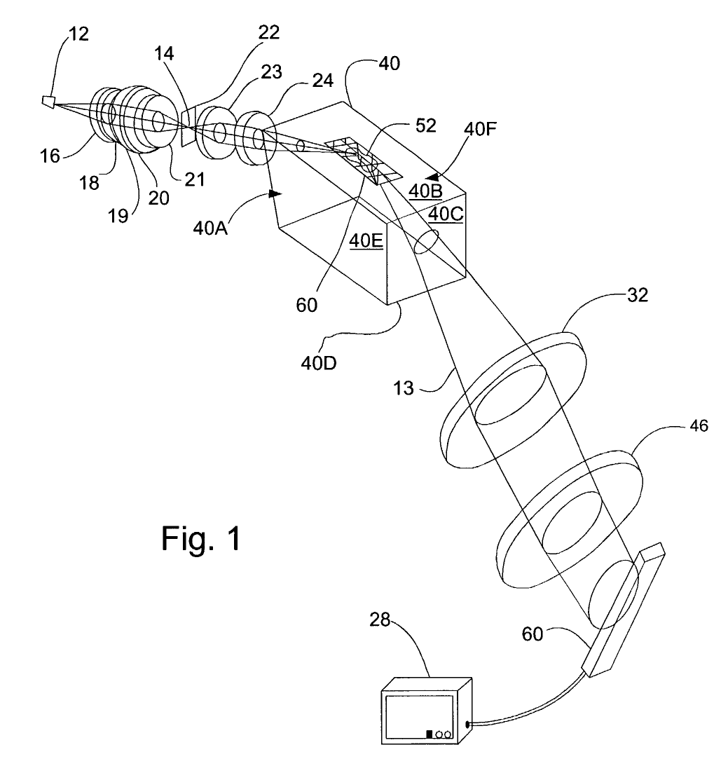

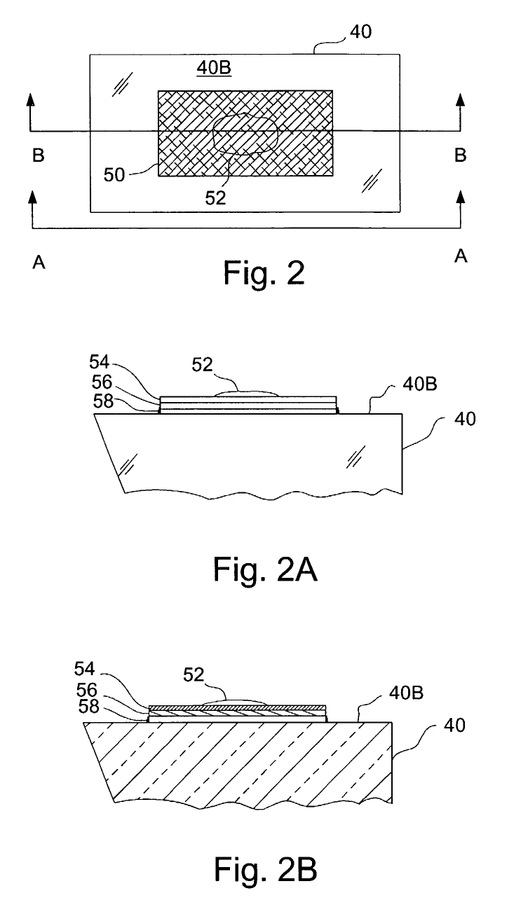

A preferred embodiment of the present invention is shown in FIG. 1 and generally designated 10. Apparatus 10 is an SPR analysis apparatus comprising a light source 12, diffuser 16, lens 18, polarizer 19, filter 20, lens 21, aperture 22, lens 23, lens 24, prism 40, sensor chip 50, lens 32, lens 46, detector 60, and processing electronics 28. These elements define an optical axis 11. Light is emitted by the light source and travels along beam path 14. The light is focused by lenses 18 and 21 before it passes through aperture 22. The light continues through lenses 23 and 24 before it enters prism 40. The light is reflected by metallic film 54 of sensor chip 50, shown in FIGS. 2A and 2B. The reflection of the light by the metallic film involves an interaction with the electron cloud of the metallic film. At certain wavelengths and angles of incidence, SPR results in the incident light being absorbed by the electrons in the metal, leading to a significant drop in the intensity of the light reflected. The reflected light continues down beam path 14, through lenses 32 and 46 to detector 60. In a preferred embodiment, detector 60 is a photodiode array, but it should be readily apparent to one having ordinary skill in the art that other apparatuses for determining the intensity of light are possible, and these modifications are within the scope of the invention as claimed. Thus, the location of the reflection minima may be found by varying the wavelength of the incident light while keeping the angle of incidence constant, or by varying the angle of incidence while keeping the wavelength constant. By comparing the location of the peak to the location of the peak for a substance of known refractive index, the refractive index of an unknown substance may be determined. Further, the presence of a substance in an unknown composition or the identity of an unknown composition may be determined by comparison of the SPR measurement results to the SPR measurement results for a known substance. These processes are well known in the art, and are detailed in U.S. Pat. No. 6,127,183, which is incorporated herein by reference.

In the present application, “angle of incidence” is intended to mean the angle between the normal to the plane containing the metallic film and the light beam as it approaches the metallic film. In a preferred embodiment, light is emitted at angles of incidence in the range of 64 to 77 degrees. This allows indices of refraction in the range of 1.3 to 1.4 to be measured by the apparatus.

In a preferred embodiment, diffuser 16 is a plate 20.0 millimeter (mm) in diameter and 1.50 mm thick. The surface through which light enters is ground with an abrasive material and the exit surface is planar. There is a 5.7 mm air gap between light source 12 and diffuser 16. Lens 18 is an 8 mm in diameter lens made of Schott SK2 glass. The light entry surface is planar and the convex light exit surface has a radius of 6.05 mm. The center thickness is 3.9 mm and the effective focal length is 9.919 mm. There is a 1.0 mm air gap between diffuser 16 and lens 18. Polarizer 19 is a 2.0 mm thick plate of HN-32 material with a diameter of 20.0 mm. There is a 0.06 mm air gap between lens 18 and polarizer 19. Filter 20 is a 3.29 mm thick plate. The center wavelength of the passband of the filter is 780 nanometers. There is a 0.44 mm air gap between polarizer 19 and filter 20. Lens 21 is an 8 mm in diameter lens made of Schott SK2 glass. The convex light entry surface has a radius of 6.05 mm and the light exit surface is planar. The center thickness is 3.9 mm and the effective focal length is 9.919 mm. There is a 3.22 mm air gap between filter 20 and lens 21. Aperture 22 is a 1 mm in diameter aperture in an opaque substance. There is a 7.4 mm air gap between lens 21 and aperture 22. Lens 23 is an 8 mm in diameter lens made of Schott SFL 56 glass. The light entry surface is planar and the convex light exit surface has a radius of 10.2 mm. The center thickness is 3.1 mm and the effective focal length is 12.882 mm. There is a 12.5 mm air gap between aperture 22 and lens 23. Lens 24 is an 8 mm in diameter lens made of Schott SFL 56 glass. The convex light entry surface has a radius of 10.2 mm and the light exit surface is planar. The center thickness is 3.1 mm and the effective focal length is 12.882 mm. There is a 0.5 mm air gap between lens 23 and lens 24. Prism 40 is trapezoidal in shape with entry face 40A (See FIG. 1) at a 70.9 degree angle with respect to top face 40B. Exit face 40C makes a 90 degree angle with respect to top face 40B. Top face 40B and bottom face 40D are parallel. Side face 40E and side face 40F are parallel. Prism 40 is made of Schott BK7 glass. There is a 3.0 mm air gap between prism 40 and lens 24. Lens 32 is a 22.0 mm in diameter lens made of Schott BK7 glass. The light entry surface is planar and the concave light exit surface has a radius of 39.0 mm. The center thickness is 3.0 mm and the effective focal length is −75.188 mm. There is a 24 mm air gap between prism 40 and lens 32. Lens 46 is a 31.0 mm in diameter lens made of Schott SK2 glass. The light entry surface is planar and the convex light exit surface has a radius of 30.0 mm. The center thickness is 8.0 mm and the effective focal length is 49.185 mm. There is a 16 mm air gap between lens 32 and lens 46. There is a 25 mm air gap between lens 46 and detector 60. However, it should be readily apparent to one skilled in the art that other configurations are possible and these modifications are intended to be within the scope of the invention as claimed.

Referring now to FIGS. 2, 2A, and 2B, sensor chip 50 is provided with thin metallic film 54 on an upwardly facing surface thereof. In a preferred embodiment, metallic film 54 includes a layer of chromium approximately ten angstroms thick for adherence to the glass surface of chip 50, and a gold layer approximately five hundred angstroms thick. In the present embodiment, an optical interface is defined by the contact area of sample 52 with the surface of metallic film 54. This contact area can be established by dropping the sample 52 onto the surface of metallic film 54, by using a flow cell designed to bring sample 52 into contact with the surface of metallic film 54, or by otherwise applying sample 52 to the surface of metallic film 54.

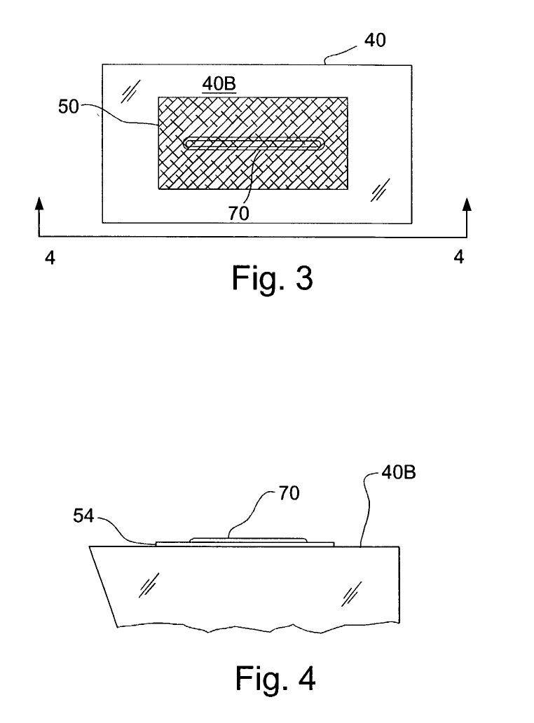

Metallic film 54 is optically coupled, indirectly, to prism sample surface 40B through transparent glass slide 56 and a thin layer of transparent oil 58 provided between the underside of glass slide 56 and sample surface 40B. As light from illumination source 12 reaches metallic film 54 at the optical interface, certain rays will be incident at a resonance angle determined by the refractive index of sample 52 and energy associated with such rays will be absorbed, while the remainder of the rays will be reflected by metallic film 54. Beam 13 comprises the rays reflected from the optical interface beneath sample 52. Of course, metallic film 54 can be optically coupled to sample surface 40B by applying the film directly to sample surface 40B, as illustrated in FIG. 3.

In an alternate embodiment, shown in FIGS. 3 and 4, gasket 70 receives sample 52 such that the optical interface is established. As light from illumination source 12 reaches metallic film 54 at the optical interface, certain rays will be incident at a resonance angle determined by the refractive index of sample 52 and energy associated with such rays will be absorbed, while the remainder of the rays will be reflected by metallic film 54. Beam 13 comprises the rays reflected from the optical interface beneath sample 52. Gasket 70 is made of a material such as room temperature vulcanizing (RTV) silicon. It should be readily apparent to one skilled in the art that means for receiving samples other than gaskets are possible, and these modifications are intended to be within the scope of the invention as claimed.

The indices of refraction of the transparent substance 56 and the prism 40 are matched to minimize reflections at the prism/sensor chip interface and to prevent refraction of the light as it enters the sensor chip. In a preferred embodiment, transparent substance 56 of sensor chip 50 and prism 40 are both made of Schott BK7 glass. However, it should be readily apparent to one having ordinary skill in the art that the sensor chip and the prism may be made of other substances and these modifications are intended to be within the scope of the invention as claimed.

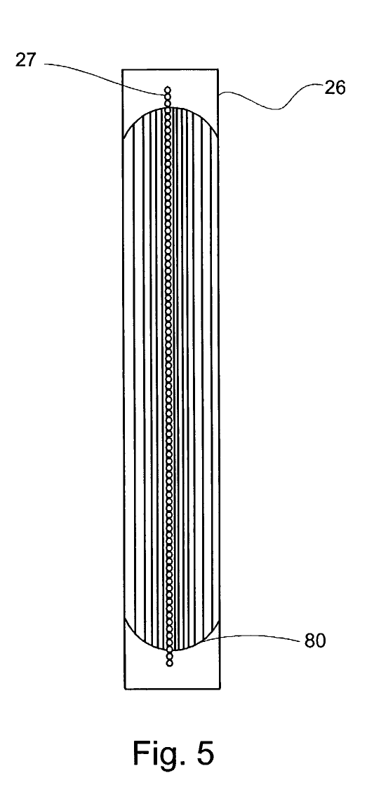

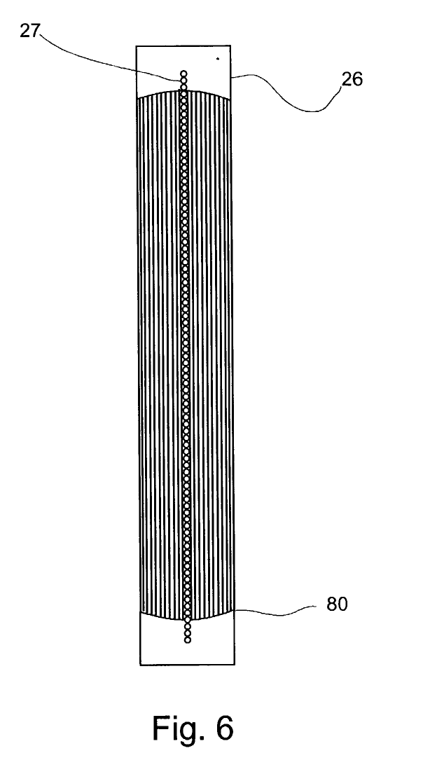

Lenses 32 and 46 redirect the light reflected by metallic film 54. There are two primary purposes for the design and configuration of these lenses. The first primary purpose is to control the size of the reflected bundle of light 13. The size of the bundle of light is optimized to fill the entire photoelement array 27 with the available reflected bundle of light. FIGS. 5A and 5B show the reflected light incident on the detector without having traversed lenses 32 and 46. If the size of the bundle of light is not controlled, the photoelement array 27 will be illuminated by underfilling incident light 80, as shown on FIG. 5A, or overfilling incident light 82, as shown on FIG. 5B. If the light incident on the detector overfills the photoelement array 27, the measurements involving the extremes of the obtainable refractive index range will not be possible due to the projection of information outside both ends of the photoelement array. If the light incident on the detector underfills the photoelement array 27, then the measurement resolution will be decreased due to the loss of pixels used on the array. The lens powers and position along optical axis 11 (shown on FIG. 1) determine the size of the bundle of light seen by the photoelement array. By utilizing lenses 32 and 46, the incident light 84 is such that it fills the entire photoelement array without exceeding the photoelement array boundaries, as shown in FIG. 6. The light 84 substantially evenly illuminates the photodiode array. The precise control on the size of the bundle of light on the photoelement array contributes to the measurement accuracy and precision.

The second primary purpose of the lens set is to allow for compactness of design. Lens 32 quickly expands the bundle of light to the required size in a short distance. Lens 46 substantially collimates the bundle for presentation to the photoelement array.

Thus, it is seen that the objects of the present invention are efficiently obtained, although modifications and changes to the invention should be readily apparent to those having ordinary skill in the art, and these modifications are intended to be within the scope of the invention as claimed.

What is claimed is:

1. An apparatus for determining a characteristic of a substance comprising:
a light source;
a prism;
a sensor chip located on said prism comprising a metallic film and a transparent substance, said metallic film operatively arranged to reflect light from said light source, said transparent substance comprising a material having an index of refraction matched to an index of refraction of said prism, said sensor chip operatively arranged to receive a sample of said substance;
focusing optics located between said light source and said prism operatively arranged to reduce spherical aberration of said light incident on said metallic film;
a detector operatively arranged to measure an intensity of light reflected by said metallic film;
collimating optics located between said prism and said detector operatively arranged to redirect said light reflected from said metallic film to substantially evenly illuminate said detector; and,
calculation means for determining said characteristic of said substance.

2. The apparatus recited in claim 1 wherein said characteristic is an index of refraction.

3. The apparatus recited in claim 2 wherein said light source is operatively arranged to emit light at a range of angles incident to said metallic film to allow measurement of indices of refraction in a range of 1.3 to 1.4.

4. The apparatus recited in claim 1 wherein said light source is operatively arranged to emit light at angles incident to said metallic film in a range of 64 degrees to 77 degrees.

5. The apparatus recited in claim 1 wherein said focusing optics comprise high index glass.

6. The apparatus recited in claim 1 wherein said collimating optics comprise a negative and a positive lens.

7. The apparatus recited in claim 1 wherein said transparent substance of said sensor chip and said prism comprise BK7 glass.

8. A method for determining a characteristic of a substance comprising:
focusing light incident on a metallic film to reduce spherical aberration, said metallic film comprising a sample space operatively arranged to receive a sample of said substance;
substantially collimating light reflected by said metallic film onto a detector to substantially evenly illuminate said detector; and,
calculating said characteristic of said substance.

9. The method recited in claim 8 wherein said characteristic is an index of refraction.

10. The method recited in claim 8 wherein said metallic film is located on a sensor chip in communication with a prism.

11. The method recited in claim 10 wherein said sensor chip has an index of refraction matching an index of refraction of said prism.

12. The method recited in claim 11 wherein said sensor chip and said prism comprise BK7 glass.

13. The method recited in claim 8 wherein said focusing light incident on a metallic film is performed by focusing optics comprising high index glass.

14. The method recited in claim 8 wherein said substantially collimating light reflected by said metallic film onto a detector is performed by collimating optics comprising a negative and a positive lens.
